(19) United States
(12) Patent Application Publication
(10) Pub. No.: US 2023/0308611 A1
(43) Pub. Date: Sep. 28, 2023

(54) MULTI-CAMERA VISION SYSTEM IN A REFRIGERATOR APPLIANCE

(71) Applicant: Haier US Appliance Solutions, Inc., Wilmington, DE (US)

(72) Inventor: Michael Goodman Schroeder, Louisville, KY (US)

(21) Appl. No.: 17/705,713

(22) Filed: Mar. 28, 2022

(51) Int. Cl. H04N 7/18; H04N 5/247; H04N 5/265; F25D 29/00

(52) U.S. Cl. CPC H04N 7/181; H04N 5/247; H04N 7/188; H04N 5/265; F25D 29/005; G06V 20/68

(57) ABSTRACT

A refrigerator appliance including a cabinet defining a chilled chamber, a door to provide selective access to the chilled chamber, and a camera assembly operable to monitor the chilled chamber. The camera assembly including a plurality of cameras coupled to a multiplexer device via a plurality of electrical cables, and a controller coupled to the multiplexer device. The plurality of cameras operable to concurrently capture data associated with the chilled chamber. Each camera of the plurality of cameras coupled to an electrical cable of the plurality of electrical cables. The multiplexer device operable to multiplex different data signals having the data associated with the chilled chamber that are concurrently provided to the multiplexer device by the plurality of cameras via the plurality of electrical cables and output a multiplex signal including the different data signals. The controller configured to perform operation(s) based in part on receipt of the multiplex signal.

### FIELD

The present disclosure relates generally to refrigerator appliances, and more particularly to a multi-camera vision system in a refrigerator appliance and methods of operating the same.

### BACKGROUND

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Notably, it is frequently desirable to have an updated inventory of items that are present within the refrigerator appliance, for example (e.g.), to facilitate reorders, to ensure food freshness or avoid spoilage, etcetera (etc.). Thus, it may be desirable to monitor food items that are added to or removed from refrigerator appliance and obtain other information related to the presence, quantity, or quality of such food items. Certain conventional refrigerator appliances have systems for monitoring food items in the refrigerator appliance. However, such systems often require user interaction, e.g., via direct input through a control panel as to the food items added or removed. By contrast, certain appliances include a camera for monitoring food items as they are added or removed from the refrigerator appliance. However, conventional camera systems may have trouble identifying a particular object, distinguishing between similar products, and precisely identifying the location of an object within the chilled chamber. In particular, conventional camera systems that include a single or limited number of cameras may have trouble performing such tasks.

Accordingly, a refrigerator appliance with systems for improved inventory management would be useful. More particularly, a refrigerator appliance that includes an inventory management system having a multi-camera system that is capable of monitoring entering and exiting inventory along with the positioning of objects within the chilled chamber would be particularly beneficial.

### BRIEF DESCRIPTION

Aspects and advantages of the present disclosure will be set forth in part in the following description, or can be learned from the description, or can be learned through practice of the embodiments.

In one example embodiment, a refrigerator appliance is provided. The refrigerator appliance can include a cabinet defining a chilled chamber. The refrigerator appliance can further include a door being rotatably hinged to the cabinet to provide selective access to the chilled chamber. The refrigerator appliance can further include a camera assembly that can be coupled to the cabinet and operable to monitor the chilled chamber. The camera assembly can include a plurality of cameras that can be coupled to a plurality of electrical cables. The plurality of cameras can be operable to concurrently capture data associated with the chilled chamber. Each camera of the plurality of cameras can be coupled to an electrical cable of the plurality of electrical cables. The camera assembly can further include a multiplexer device that can be coupled to the plurality of electrical cables. The multiplexer device can be operable to multiplex different data signals concurrently provided to the multiplexer device by the plurality of cameras via the plurality of electrical cables and output a multiplex signal having the different data signals. The different data signals can include the data associated with the chilled chamber. The camera assembly can further include a controller coupled to the multiplexer device. The controller can be configured to perform one or more operations based at least in part on receipt of the multiplex signal.

In another example embodiment, a method of implementing inventory management within a refrigerator appliance is provided. The refrigerator appliance can include a chilled chamber and a camera assembly having a plurality of cameras positioned to monitor the chilled chamber. The method can include obtaining, by a controller operatively coupled to the camera assembly, a multiplex signal from a multiplex device coupled to the controller. The multiplex signal can include different data signals concurrently provided to the multiplexer device by the plurality of cameras via a plurality of electrical cables coupled to the multiplexer device and the plurality of cameras. The different data signals can include data associated with the chilled chamber. The method can further include performing, by the controller, one or more operations based at least in part on receipt of the multiplex signal from the multiplexer device.

In another example embodiment, a refrigerator appliance is provided. The refrigerator appliance can include a cabinet defining a chilled chamber. The refrigerator appliance can further include a door being rotatably hinged to the cabinet to provide selective access to the chilled chamber. The refrigerator appliance can further include a camera assembly that can be coupled to the cabinet and operable to monitor the chilled chamber. The camera assembly can include a first multiplexer device that can be coupled to a first pair of cameras and a first electrical cable. The first multiplexer device can be operable to output a first multiplex signal onto the first electrical cable. The first multiplex signal can include different first data signals concurrently provided to the first multiplexer device by the first pair of cameras. The camera assembly can further include a second multiplexer device that can be coupled to a second pair of cameras and a second electrical cable. The second multiplexer device can be operable to output a second multiplex signal onto the second electrical cable. The second multiplex signal can include different second data signals concurrently provided to the second multiplexer device by the second pair of cameras. The camera assembly can further include a demultiplexer device that can be coupled to the first electrical cable and the second electrical cable. The demultiplexer device can be operable to demultiplex the first multiplex signal into the different first data signals and the second multiplex signal into the different second data signals. The camera assembly can further include a controller that can be coupled to the demultiplexer device. The controller can be configured to perform one or more operations based at least in part on receipt of at least one of the different first data signals or the different second data signals.

These and other features, aspects, and advantages of various embodiments of the present disclosure will become better understood with reference to the following description and appended claims. The accompanying drawings, which are incorporated in and constitute a part of this specification, illustrate embodiments of the present disclosure and, together with the description, serve to explain the related principles of the present disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 illustrates a perspective view of an example, non-limiting refrigerator appliance according to one or more example embodiments of the present disclosure.

FIG. 2 illustrates a perspective view of the example refrigerator appliance of FIG. 1, with doors shown in an open position to reveal an example, non-limiting inventory management system according to one or more example embodiments of the present disclosure.

FIG. 3 illustrates a flow diagram of an example, non-limiting method for operating the example inventory management system of FIG. 2 according to one or more example embodiments of the present disclosure.

FIG. 4 illustrates a first image obtained using a camera of the example inventory management system of FIG. 2 according to one or more example embodiments of the present disclosure.

FIG. 5 illustrates a second image obtained using a camera of the example inventory management system of FIG. 2 according to one or more example embodiments of the present disclosure.

FIG. 6 illustrates a diagram of an example, non-limiting image comparison and object identification process using the example inventory management system of FIG. 2 according to one or more example embodiments of the present disclosure.

FIG. 7 illustrates a diagram of an example, non-limiting object motion tracking process using the example inventory management system of FIG. 2 according to one or more example embodiments of the present disclosure.

FIG. 8 illustrates a perspective view of the example refrigerator appliance of FIG. 1 including an example, non-limiting inventory management system having a plurality of cameras according to one or more example embodiments of the present disclosure.

FIGS. 9, 10, and 11 each illustrate a block diagram of the example inventory management system of FIGS. 2 and/or 8 according to one or more example embodiments of the present disclosure.

FIG. 12 illustrates a flow diagram of an example, non-limiting method to operate the example inventory management system of FIGS. 2, 8, and/or 9 according to one or more example embodiments of the present disclosure.

Repeat use of reference characters and/or numerals in the present specification and/or drawings is intended to represent the same or analogous features, elements, or operations of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As referenced herein, the term “entity” refers to a human, a user, an end-user, a consumer, a computing device and/or program (e.g., a processor, computing hardware and/or software, an application, etc.), an agent, a machine learning (ML) and/or artificial intelligence (AI) algorithm, model, system, and/or application, and/or another type of entity that can implement and/or facilitate implementation of one or more embodiments of the present disclosure as described herein, illustrated in the accompanying drawings, and/or included in the appended claims. As used herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling, etc.), mechanical coupling, operative coupling, optical coupling, and/or physical coupling.

As used herein, the terms “upstream” and “downstream” refer to the relative flow direction with respect to fluid flow in a fluid pathway. For example, “upstream” refers to the flow direction from which the fluid flows, and “downstream” refers to the flow direction to which the fluid flows. As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language can correspond to the precision of an instrument for measuring the value. For example, the approximating language can refer to being within a 10 percent margin.

Referring now to the figures. Example refrigerator appliances, inventory management systems, camera assemblies, and corresponding methods of operation will be described in accordance with one or more embodiments of the present disclosure.

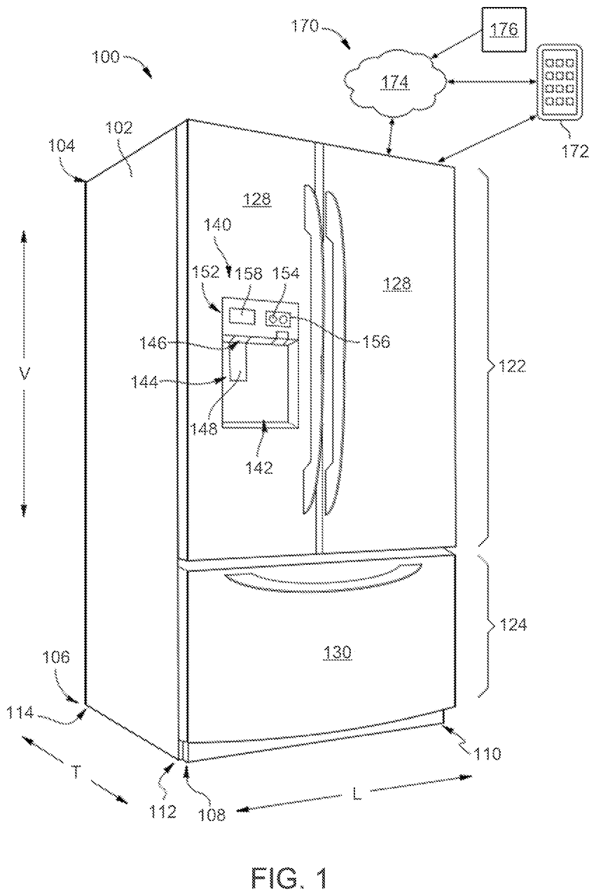

FIG. 1 illustrates a perspective view of an example, non-limiting refrigerator appliance 100 according to one or more example embodiments of the present disclosure. As illustrated, refrigerator appliance 100 generally defines a vertical direction V, a lateral direction L, and a transverse direction T, each of which is mutually perpendicular, such that an orthogonal coordinate system is generally defined.

According to example embodiments, refrigerator appliance 100 includes a cabinet 102 that is generally configured for containing and/or supporting various components of refrigerator appliance 100 and which can also define one or more internal chambers or compartments of refrigerator appliance 100. In this regard, as used herein, the terms “cabinet,” “housing,” and the like are generally intended to refer to an outer frame or support structure for refrigerator appliance 100, for example (e.g.), including any suitable number, type, and configuration of support structures formed from any suitable materials, such as a system of elongated support members, a plurality of interconnected panels, or some combination thereof. It should be appreciated that cabinet 102 does not necessarily require an enclosure and can simply include open structure supporting various elements of refrigerator appliance 100. By contrast, cabinet 102 can enclose some or all portions of an interior of cabinet 102. It should be appreciated that cabinet 102 can have any suitable size, shape, and configuration while remaining within the scope of the present disclosure.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front side 112 and a rear 114 along the transverse direction T. In general, terms such as “left,” “right,” “front,” “rear,” “top,” or “bottom” are used with reference to the perspective of a user accessing refrigerator appliance 100.

Cabinet 102 defines chilled chambers for receipt of food items for storage. In particular, cabinet 102 defines fresh food chamber 122 positioned at or adjacent top 104 of cabinet 102 and a freezer chamber 124 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present disclosure can be applied to other appliances as well. Consequently, the description set forth herein is for illustrative purposes only and is not intended to be limiting in any aspect to any particular appliance or configuration.

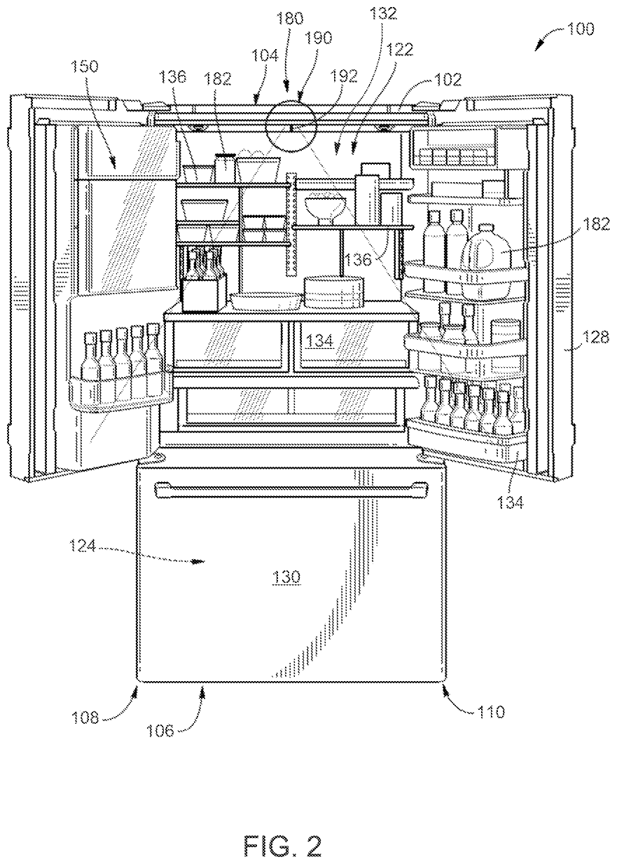

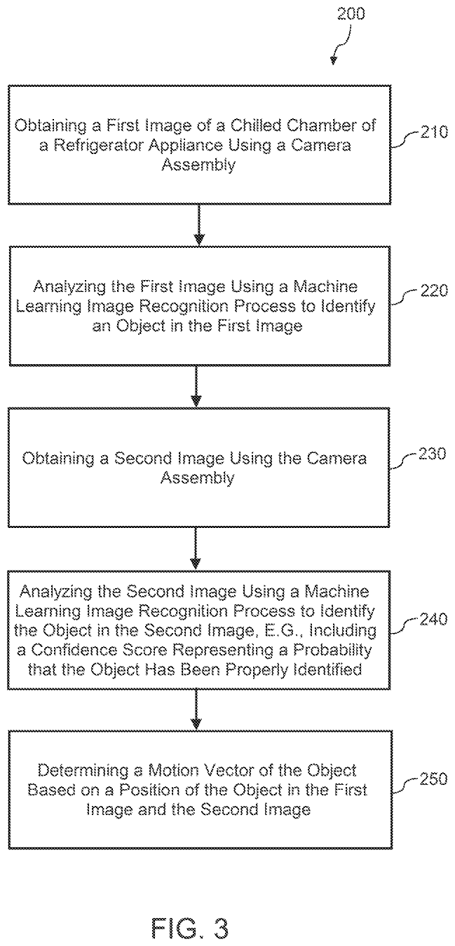

Refrigerator doors 128 are rotatably hinged to an edge of cabinet 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. In general, refrigerator doors 128 form a seal over a front opening 132 (FIGS. 2 and 3) defined by cabinet 102 (e.g., extending within a plane defined by the vertical direction V and the lateral direction L). In this regard, a user can place items within fresh food chamber 122 through front opening 132 when refrigerator doors 128 are open and can then close refrigerator doors 128 to facilitate climate control. Refrigerator doors 128 and freezer door 130 are shown in the closed configuration in FIG. 1. One skilled in the art will appreciate that other chamber and door configurations are possible and within the scope of the present disclosure.

FIG. 2 illustrates a perspective view of refrigerator appliance 100, with refrigerator doors 128 shown in an open position to reveal one or more components of refrigerator appliance 100 and/or objects therein according to one or more example embodiments of the present disclosure. As shown in FIG. 2, various storage components are mounted within fresh food chamber 122 to facilitate storage of food items therein as will be understood by those skilled in the art. In particular, the storage components can include bins 134 and shelves 136. Each of these storage components are configured to receive one or more objects 182 (e.g., food items, beverages) and can assist with organizing such object(s) 182. As illustrated, bins 134 can be mounted on refrigerator doors 128 or can slide into a receiving space in fresh food chamber 122. It should be appreciated that the illustrated storage components are used only for the purpose of explanation and that other storage components can be used and can have different sizes, shapes, and configurations.

Referring again to FIG. 1, a dispensing assembly 140 will be described according to example embodiments of the present disclosure. Although several different example embodiments of dispensing assembly 140 will be illustrated and described, similar reference numerals can be used to refer to similar components and features. Dispensing assembly 140 is generally configured for dispensing liquid water and/or ice. Although an example dispensing assembly 140 is illustrated and described herein, it should be appreciated that variations and modifications can be made to dispensing assembly 140 while remaining within the present disclosure.

Dispensing assembly 140 and its various components can be positioned at least in part within a dispenser recess 142 defined on one of refrigerator doors 128. In this regard, dispenser recess 142 is defined on a front side 112 of refrigerator appliance 100 such that a user can operate dispensing assembly 140 without opening refrigerator door 128. In addition, dispenser recess 142 is positioned at a predetermined elevation convenient for a user to access ice and enabling the user to access ice without the need to bend-over. In the example embodiment, dispenser recess 142 is positioned at a level that approximates the chest level of a user.

Dispensing assembly 140 includes an ice or water dispenser 144 including a discharging outlet 146 for discharging ice from dispensing assembly 140. An actuating mechanism 148, shown as a paddle, is mounted below discharging outlet 146 for operating ice or water dispenser 144. In alternative example embodiments, any suitable actuating mechanism can be used to operate ice dispenser 144. For example, ice or water dispenser 144 can include a sensor (e.g., an ultrasonic sensor) or a button rather than the paddle. Discharging outlet 146 and actuating mechanism 148 are an external part of ice or water dispenser 144 and are mounted in dispenser recess 142. By contrast, refrigerator door 128 can define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etcetera (etc.), such as a water dispensing button and an ice-dispensing button, for selecting a desired mode of operation such as crushed or non-crushed ice. In addition, inputs 154 can be used to specify a fill volume or method of operating dispensing assembly 140. In this regard, inputs 154 can be in communication with a processing device or controller 156. Signals generated in controller 156 operate refrigerator appliance 100 and dispensing assembly 140 in response to selector input(s) 154. Additionally, a display 158, such as an indicator light or a screen, can be provided on control panel 152. Display 158 can be in communication with controller 156 and can display information in response to signals from controller 156.

As used herein, “processing device” or “controller” can refer to one or more microprocessors or semiconductor devices and is not restricted necessarily to a single element. The processing device or controller (e.g., controller 156) can be programmed to operate refrigerator appliance 100, dispensing assembly 140, and one or more other components of refrigerator appliance 100. The processing device or controller (e.g., controller 156) can include, or be associated with, one or more memory elements (e.g., non-transitory storage media, non-transitory computer-readable storage media). In some embodiments, such memory element(s) include electrically erasable, programmable read only memory (EEPROM). Generally, the memory element(s) can store information accessible by a processing device or controller (e.g., controller 156), including instructions that can be executed by the processing device or controller. Optionally, the instructions can be software or any set of instructions and/or data that when executed by the processing device or controller (e.g., controller 156), cause the processing device to perform operations.

Referring still to FIG. 1, a schematic diagram of an external communication system 170 will be described according to an example embodiment of the present disclosure. In general, external communication system 170 is configured for permitting interaction, data transfer, and other communications between refrigerator appliance 100 and one or more external devices. For example, this communication can be used to provide and receive various types of data in various types of formats (e.g., data signals, media, images, video, audio, multiplexed or demultiplexed data signals), operating parameters, user instructions or notifications, performance characteristics, user preferences, or any other suitable information for improved performance of refrigerator appliance 100. In addition, it should be appreciated that external communication system 170 can be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as an external device 172. As described in more detail below, these communications can be facilitated using a wired or wireless connection, such as via a network 174. In general, external device 172 can be any suitable device separate from refrigerator appliance 100 that is configured to provide and/or receive communications, information, data, or commands from a user. In this regard, external device 172 can be, for example, a personal phone, a smartphone, a tablet, a laptop or personal computer, a wearable device, a smart home system, or another mobile or remote device.

In addition, a remote server 176 can be in communication with refrigerator appliance 100 and/or external device 172 through network 174. In this regard, for example, remote server 176 can be a cloud-based server, and is thus located at a distant location, such as in a separate state, country, etc. According to an example embodiment, external device 172 can communicate with a remote server 176 over network 174, such as the Internet, to transmit and/or receive data or information, provide user inputs, receive user notifications or instructions, interact with or control refrigerator appliance 100, etc. In addition, external device 172 and remote server 176 can communicate with refrigerator appliance 100 to communicate similar information. According to example embodiments, remote server 176 can be configured to receive and analyze images, video, audio, and/or other data obtained by a camera assembly 190 (FIGS. 2 and 3) of refrigerator appliance 100, e.g., to facilitate inventory analysis.

In general, communication between refrigerator appliance 100, external device 172, remote server 176, and/or other user devices or appliances can be carried using any type of wired or wireless connection and using any suitable type of communication network, non-limiting examples of which are provided below. For example, external device 172 can be in direct or indirect communication with refrigerator appliance 100 through any suitable wired or wireless communication connections or interfaces, such as network 174. For example, network 174 can include one or more of a local area network (LAN), a wide area network (WAN), a personal area network (PAN), the Internet, a cellular network, any other suitable short-range or long-range wireless networks, etc. In addition, communications can be transmitted using any suitable communications devices or protocols, such as via Wi-Fi®, Bluetooth®, Zigbee®, wireless radio, laser, infrared, Ethernet type devices and interfaces, etc. In addition, such communication can use a variety of communication protocols (e.g., transmission control protocol/internet protocol (TCP/IP), hypertext transfer protocol (HTTP), simple mail transfer protocol (SMTP), file transfer protocol (FTP), etc.), encodings or formats (e.g., hypertext markup language (HTML), extensible markup language (XML), etc.), and/or protection schemes (e.g., virtual private network (VPN), secure HTTP, secure shell (SSH), secure sockets layer (SSL), etc.).

External communication system 170 is described herein according to an example embodiment of the present disclosure. However, it should be appreciated that the example functions and configurations of external communication system 170 provided herein are used only as examples to facilitate description of aspects of the present disclosure. System configurations can vary, other communication devices can be used to communicate directly or indirectly with one or more associated appliances, other communication protocols and steps can be implemented, etc. These variations and modifications are contemplated as within the scope of the present disclosure.

Referring now generally to FIG. 2, refrigerator appliance 100 can further include an inventory management system 180 that is generally configured to monitor one or more chambers of refrigerator appliance 100 to monitor the addition and/or removal of inventory. More specifically, as described in more detail below, inventory management system 180 can include a plurality of sensors, cameras, or other detection devices that are used to monitor fresh food chamber 122 and/or freezer chamber 124 to detect objects 182 (e.g., food items, beverages) that are positioned in or removed from fresh food chamber 122 and/or freezer chamber 124. In this regard, inventory management system 180 can use data from each of these devices to obtain a complete representation or knowledge of the identity, position, and/or other qualitative or quantitative characteristics of objects 182 within fresh food chamber 122 and/or freezer chamber 124. Although inventory management system 180 is described herein as monitoring fresh food chamber 122 for the detection of objects 182, it should be appreciated that aspects of the present disclosure can be used to monitor objects or items in any other suitable appliance, chamber (e.g., freezer chamber 124), etc.

As shown schematically in FIG. 2, inventory management system 180 can include a camera assembly 190 coupled to refrigerator appliance 100 (e.g., to cabinet 102) that is generally positioned and configured for obtaining images and/or video of refrigerator appliance 100 during operation. Specifically, according to the illustrated embodiment, camera assembly 190 includes one or more cameras 192 that are mounted to cabinet 102, to refrigerator doors 128, or are otherwise positioned in view of fresh food chamber 122. Although camera assembly 190 is described herein as being used to monitor fresh food chamber 122 of refrigerator appliance 100, it should be appreciated that aspects of the present disclosure can be used to monitor any other suitable regions of any other suitable appliance, e.g., such as freezer chamber 124. As best shown in FIG. 2, a camera 192 of camera assembly 190 is mounted to cabinet 102 at front opening 132 of fresh food chamber 122 and is oriented to have a field of view directed across front opening 132 and/or into fresh food chamber 122.

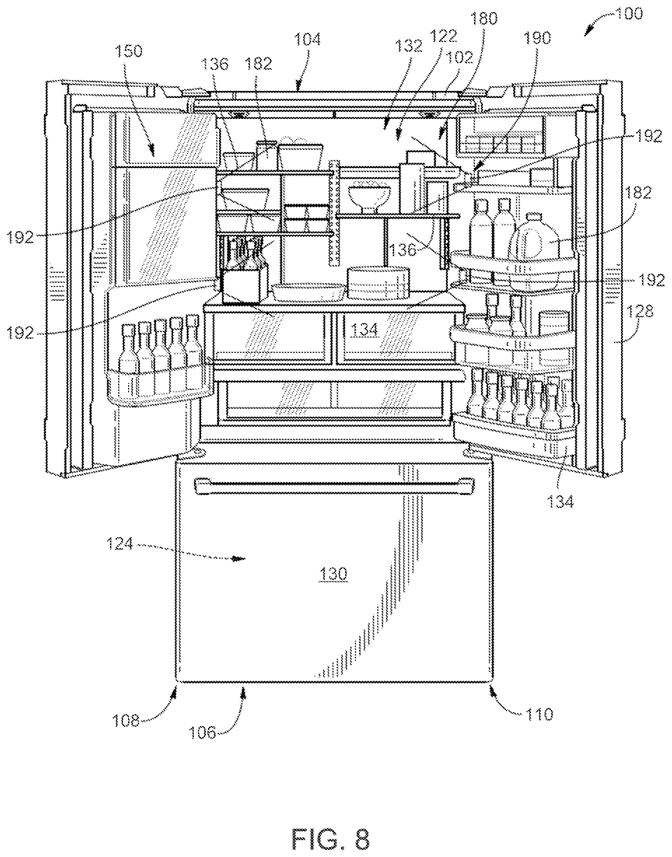

Although a single camera 192 is illustrated in FIG. 2, it should be appreciated that camera assembly 190 can include a plurality of cameras 192 positioned within and/or coupled (e.g., mounted) to cabinet 102, wherein each of the plurality of cameras 192 has a specified monitoring zone or monitoring range positioned around fresh food chamber 122. In this regard, for example, the field of view of each camera 192 can be limited to, directed to, or focused on a certain monitoring zone, monitoring range, or a specific area within fresh food chamber 122. Specifically, referring now briefly to FIG. 8, an inventory management system 180 having a plurality of cameras 192 according to one or more example embodiments of the present disclosure is provided. As shown, cameras 192 can be mounted to a sidewall of fresh food chamber 122 and can be spaced apart along the vertical direction V to cover different monitoring zones.

Notably, however, it can be desirable to position each camera 192 proximate front opening 132 of fresh food chamber 122 and orient each camera 192 such that the field of view of each camera 192 is directed into fresh food chamber 122. In this manner, privacy concerns related to obtaining images of the user of the refrigerator appliance 100 can be mitigated or avoided altogether. According to example embodiments, camera assembly 190 can be used to facilitate an inventory management process for refrigerator appliance 100. As such, each camera 192 can be positioned at an opening to fresh food chamber 122 to monitor objects 182 (e.g., food items, beverages) that are being added to or removed from fresh food chamber 122.

According to still other embodiments, each camera 192 can be oriented in any other suitable manner for monitoring any other suitable region within or around refrigerator appliance 100. It should be appreciated that according to alternative embodiments, camera assembly 190 can include any suitable number, type, size, and configuration of camera(s) 192 for obtaining images of any suitable areas or regions within or around refrigerator appliance 100. In addition, it should be appreciated that each camera 192 can include features for adjusting its field of view and/or orientation.

It should be appreciated that the images and/or video obtained by camera assembly 190 can vary in number, frequency, angle, resolution, detail, etc. in order to improve the clarity of the particular regions surrounding or within refrigerator appliance 100. In addition, according to example embodiments, controller 156 can be configured for illuminating the chilled chamber using one or more light sources prior to obtaining images. Notably, controller 156 of refrigerator appliance 100 (or any other suitable dedicated controller) can be communicatively coupled to camera assembly 190 and can be programmed or configured for analyzing the images obtained by camera assembly 190, e.g., in order to identify items being added or removed from refrigerator appliance 100, as described in detail below.

In general, controller 156 can be coupled (e.g., electrically, communicatively, operatively) to camera assembly 190 for analyzing one or more images and/or video obtained by camera assembly 190 to extract useful information regarding objects 182 located within fresh food chamber 122. In this regard, for example, images and/or video obtained by camera assembly 190 can be used to extract a barcode, identify a product, monitor the motion of the product, or obtain other product information related to object 182. Notably, this analysis can be performed locally (e.g., on controller 156) or can be transmitted to a remote server (e.g., remote server 176 via external communication system 170) for analysis. Such analysis is intended to facilitate inventory management, e.g., by identifying a food item being added to and/or removed from the chilled chamber.

Now that the construction and configuration of refrigerator appliance 100 and camera assembly 190 have been presented according to an example embodiment of the present disclosure, an example method 200 for operating a camera assembly 190 is provided. Method 200 can be used to operate camera assembly 190, or to operate any other suitable camera assembly for monitoring appliance operation or inventory. In this regard, for example, controller 156 can be configured for implementing method 200. However, it should be appreciated that the example method 200 is discussed herein only to describe example aspects of the present disclosure and is not intended to be limiting.

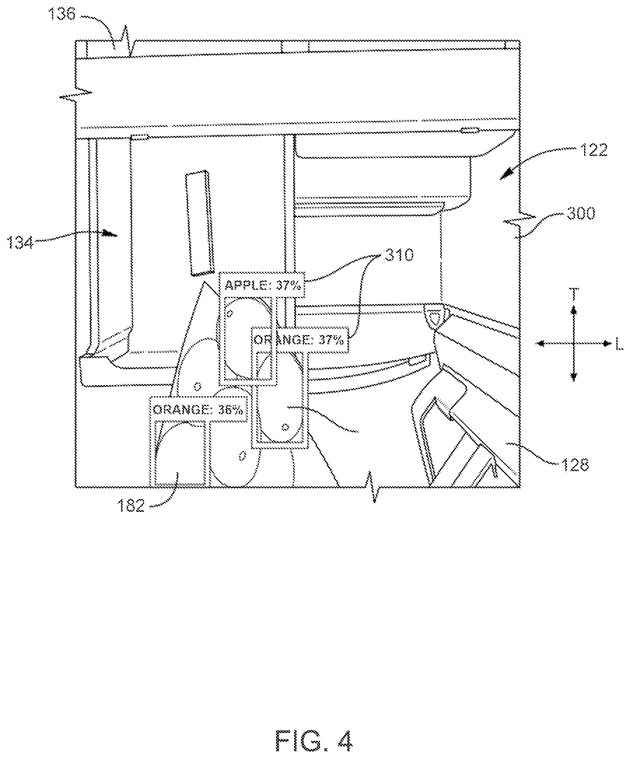

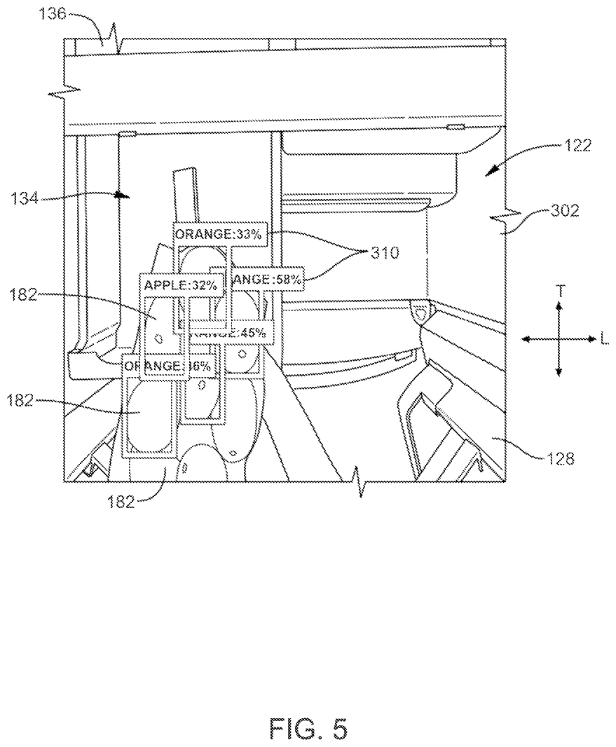

As shown in FIG. 3, method 200 includes, at step 210, obtaining a first image of a chilled chamber of a refrigerator appliance using a camera assembly. For example, continuing the example from above, camera assembly 190 of refrigerator appliance 100 can obtain one or more images within fresh food chamber 122, which can include in its field of view a plurality of objects 182. In this regard, camera assembly 190 of refrigerator appliance 100 can obtain one or more images (e.g., such as first image 300 and a second image 302 identified in FIGS. 4 and 5, respectively) of fresh food chamber 122, freezer chamber 124, or any other zone or region within or around refrigerator appliance 100. Specifically, according to an example embodiment, camera 192 is oriented down from a top center of cabinet 102 and has a field of view (e.g., as shown in the photos of FIGS. 4 and 5) that covers a width of fresh food chamber 122. Moreover, this field of view can be centered on front opening 132 at a front of cabinet 102, e.g., where refrigerator doors 128 are seated against a front of cabinet 102. In this manner, the field of view of camera 192, and the resulting images obtained, can capture any motion or movement of an object into and/or out of fresh food chamber 122. The images obtained by camera assembly 190 can include one or more still images, one or more video clips, or any other suitable type and number of images suitable for identification of objects 182 (e.g., food items, beverages) or inventory analysis.

Notably, camera assembly 190 can obtain images upon any suitable trigger, such as a time-based imaging schedule where camera assembly 190 periodically images and monitors fresh food chamber 122. According to still other embodiments, camera assembly 190 can periodically take low resolution images until motion is detected (e.g., via image differentiation of low resolution images), at which time one or more high resolution images can be obtained. According to still other embodiments, refrigerator appliance 100 can include one or more motion sensors (e.g., optical, acoustic, electromagnetic, etc.) that are triggered when an object 182 is being added to or removed from fresh food chamber 122, and camera assembly 190 can be operably coupled to such motion sensors to obtain images of the object 182 during such movement.

According to still other embodiments, refrigerator appliance 100 can include a door switch that detects when refrigerator door 128 is opened, at which point camera assembly 190 can begin obtaining one or more images. According to example embodiments, the images 300, 302 can be obtained continuously or periodically while refrigerator doors 128 are open. In this regard, obtaining images 300, 302 can include determining that the door of the refrigerator appliance is open and capturing images at a set frame rate while the door is open. Notably, the motion of the food items between image frames can be used to determine whether the object 182 is being removed from or added into fresh food chamber 122. It should be appreciated that the images obtained by camera assembly 190 can vary in number, frequency, angle, resolution, detail, etc. in order to improve the clarity of objects 182. In addition, according to example embodiments, controller 156 can be configured for illuminating a refrigerator light (not shown) while obtaining images 300, 302. Other suitable triggers are possible and within the scope of the present disclosure.

Step 220 can include analyzing the first image using a machine learning image recognition process to identify an object in the first image. It should be appreciated that this analysis can utilize any suitable image analysis techniques, image decomposition, image segmentation, image processing, etc. This analysis can be performed entirely by controller 156, can be offloaded to a remote server for analysis, can be analyzed with user assistance (e.g., via control panel 152), or can be analyzed in any other suitable manner. According to example embodiments of the present disclosure, the analysis performed at step 220 can include a machine learning image recognition process.

According to example embodiments, this image analysis can use any suitable image processing technique, image recognition process, etc. As used herein, the terms “image analysis” and the like can be used generally to refer to any suitable method of observation, analysis, image decomposition, feature extraction, image classification, etc. of one or more images, videos, or other visual representations of an object. As explained in more detail below, this image analysis can include the implementation of image processing techniques, image recognition techniques, or any suitable combination thereof. In this regard, the image analysis can use any suitable image analysis software or algorithm to constantly or periodically monitor a moving object within fresh food chamber 122. It should be appreciated that this image analysis or processing can be performed locally (e.g., by controller 156) or remotely (e.g., by offloading image data to a remote server or network, e.g., remote server 176).

Specifically, the analysis of the one or more images can include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm can rely on image differentiation, e.g., such as a pixel-by-pixel comparison of two sequential images. This comparison can help identify substantial differences between the sequentially obtained images, e.g., to identify movement, the presence of a particular object, the existence of a certain condition, etc. For example, one or more reference images can be obtained when a particular condition exists, and these references images can be stored for future comparison with images obtained during appliance operation. Similarities and/or differences between the reference image and the obtained image can be used to extract useful information for improving appliance performance. For example, image differentiation can be used to determine when a pixel level motion metric passes a predetermined motion threshold.

The processing algorithm can further include measures for isolating or eliminating noise in the image comparison, e.g., due to image resolution, data transmission errors, inconsistent lighting, or other imaging errors. By eliminating such noise, the image processing algorithms can improve accurate object detection, avoid erroneous object detection, and isolate the important object, region, or pattern within an image. In addition, or alternatively, the image processing algorithms can use other suitable techniques for recognizing or identifying particular items or objects, such as edge matching, divide-and-conquer searching, greyscale matching, histograms of receptive field responses, or another suitable routine (e.g., executed at the controller 156 based on one or more captured images from one or more cameras). Other image processing techniques are possible and within the scope of the present disclosure.

In addition to the image processing techniques described above, the image analysis can include utilizing artificial intelligence (AI), such as a machine learning image recognition process, a neural network classification module, any other suitable artificial intelligence (AI) technique, and/or any other suitable image analysis techniques, examples of which will be described in more detail below. Moreover, each of the example image analysis or evaluation processes described below can be used independently, collectively, or interchangeably to extract detailed information regarding the images being analyzed to facilitate performance of one or more methods described herein or to otherwise improve appliance operation. According to example embodiments, any suitable number and combination of image processing, image recognition, or other image analysis techniques can be used to obtain an accurate analysis of the obtained images.

In this regard, the image recognition process can use any suitable artificial intelligence technique, for example, any suitable machine learning technique, or for example, any suitable deep learning technique. According to an example embodiment, the image recognition process can include the implementation of a form of image recognition called region based convolutional neural network (R-CNN) image recognition. Generally speaking, R-CNN can include taking an input image and extracting region proposals that include a potential object or region of an image. In this regard, a “region proposal” can be one or more regions in an image that could belong to a particular object or can include adjacent regions that share common pixel characteristics. A convolutional neural network is then used to compute features from the region proposals and the extracted features will then be used to determine a classification for each particular region.

According to still other embodiments, an image segmentation process can be used along with the R-CNN image recognition. In general, image segmentation creates a pixel-based mask for each object in an image and provides a more detailed or granular understanding of the various objects within a given image. In this regard, instead of processing an entire image—that is (i.e.), a large collection of pixels, many of which might not contain useful information—image segmentation can involve dividing an image into segments (e.g., into groups of pixels containing similar attributes) that can be analyzed independently or in parallel to obtain a more detailed representation of the object or objects in an image. This can be referred to herein as “mask R-CNN” and the like, as opposed to a regular R-CNN architecture. For example, mask R-CNN can be based on fast R-CNN which is slightly different than R-CNN. For example, R-CNN first applies a convolutional neural network (CNN) and then allocates it to zone recommendations on the property map instead of the initially split into zone recommendations. In addition, according to example embodiments, standard CNN can be used to obtain, identify, or detect any other qualitative or quantitative data related to one or more objects or regions within the one or more images. In additional or alternative embodiments, a K-means algorithm can be used.

According to still other embodiments, the image recognition process can use any other suitable neural network process while remaining within the scope of the present disclosure. For example, the step of analyzing the one or more images can include using a deep belief network (DBN) image recognition process. A DBN image recognition process can generally include stacking many individual unsupervised networks that use each network's hidden layer as the input for the next layer. According to still other embodiments, the step of analyzing one or more images can include the implementation of a deep neural network (DNN) image recognition process, which generally includes the use of a neural network (e.g., computing systems inspired by and/or based on the biological neural networks) with multiple layers between input and output. Other suitable image recognition processes, neural network processes, artificial intelligence analysis techniques, and combinations of the above described or other known methods can be used while remaining within the scope of the present disclosure.

In addition, it should be appreciated that various transfer techniques can be used but use of such techniques is not required. If using transfer techniques learning, a neural network architecture can be pretrained such as VGG16, VGG19, or ResNet50 with a public dataset then the last layer can be retrained with an appliance specific dataset. In addition, or alternatively, the image recognition process can include detection of certain conditions based on comparison of initial conditions and/or can rely on image subtraction techniques, image stacking techniques, image concatenation, etc. For example, the subtracted image can be used to train a neural network with multiple classes for future comparison and image classification.

It should be appreciated that the machine learning image recognition models can be actively trained by the appliance with new images, can be supplied with training data from the manufacturer or from another remote source, or can be trained in any other suitable manner. For example, according to example embodiments, this image recognition process relies at least in part on a neural network trained with a plurality of images of the appliance in different configurations, experiencing different conditions, or being interacted with in different manners. This training data can be stored locally or remotely and can be communicated to a remote server for training other appliances and models.

It should be appreciated that image processing and machine learning image recognition processes can be used together to facilitate improved image analysis, object detection, or to extract other useful qualitative or quantitative data or information from the one or more images that can be used to improve the operation or performance of the appliance. Indeed, the methods described herein can use any or all of these techniques interchangeably to improve image analysis process and facilitate improved appliance performance and consumer satisfaction. The image processing algorithms and machine learning image recognition processes described herein are only example and are not intended to limit the scope of the present disclosure in any manner.

Step 230 can include obtaining a second image 302 using the camera assembly. For example, second image 302 can be obtained immediately after first image 300 is obtained at step 210. In general, first image 300 and second image 302 can both be obtained while object 182 is in the process of being inserted in to or removed from fresh food chamber 122, such that the trajectory of object 182 can be determined, as described in more detail below.

Step 240 can include analyzing the second image using a machine learning image recognition process to identify the object in the second image. In this regard, step 240 can include similar image analysis as that described above with regard to step 220.

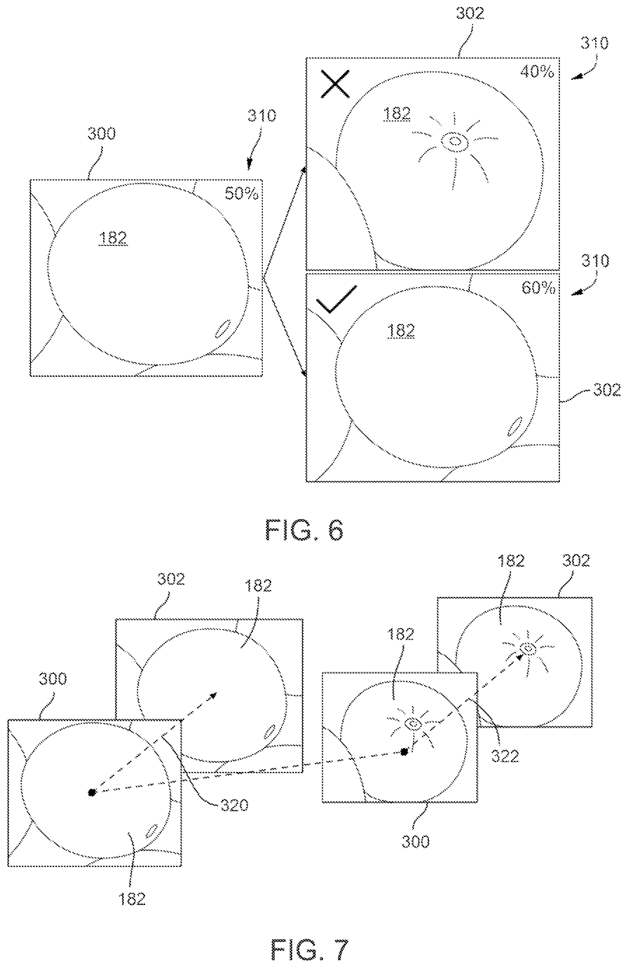

Referring now briefly to FIGS. 4, 5, 6, and 7, various images (e.g., including first image 300 and second image 302) obtained by camera assembly 190 during the implementation of method 200 are illustrated. As shown for example in FIG. 4, the image analysis performed at step 220 can identify a plurality of objects within the first image 300 and second image 302, e.g., based on training of the machine learning model using similar objects 182 (e.g., as illustrated herein as either apples or oranges). In addition to an object identification, the machine learning image recognition process can provide a confidence score (e.g., as identified generally by reference numeral 310 for each of the objects 182 identified in FIGS. 4, 5, and 6). In this regard, for example, the confidence score 310 can generally represent the probability that the object has been properly identified by the machine learning model.

It should be appreciated that the confidence score 310 can be increased by obtaining more images of the same object 182 at different angles, at different times, different positions, etc. Accordingly, method 200 can further include the step of obtaining a third image using camera assembly 190 where the third image also contains object 182 from first image 300 and second image 302. Method 200 can further include analyzing a third image to identify the object in the third image in increasing the confidence score based at least in part on the analysis of the third image to identify the object. In this regard, if the machine learning model identifies a single object 182 as being the same orange, the confidence level can be increased, e.g., as shown from the object identifications in FIGS. 4 and 5. A positive identification of the same orange in a third image can further increase the confidence score. By contrast, a negative identification of the same object 182 can be used to reduce the confidence score.

Notably, confidence score 310 can be an output from the machine learning model and can be based on any suitable characteristics of the object 182 being monitored or tracked. For example, each object 182 can have identifiable features, such as stems, discolorations, imperfections, or other features which can be identifiable and associated with that particular object 182 (e.g., similar to a fingerprint for that object). Machine learning image recognition model can identify each object based on its particular fingerprint and can use identifiable features from other images to increase the accuracy of object identification. Although this comparison of multiple images to improve the confidence score of an object identification is described herein with respect to individual oranges or apples, it should be appreciated that the models can be extrapolated to the identification of any of a plurality of objects using any suitable number of images.

Step 250 can include determining a motion vector of the object based on a position of the object in the first image and the second image. Specifically, as best illustrated in FIG. 7, a motion vector 320 of a first object 182 (e.g., a first orange) is shown between a first image 300 and a second image 302. In this regard, if an object 182 (e.g., such as an orange) is identified in both first image 300 and second image 302, method 200 can include determining a trajectory or motion vector 320 associated with the movement of that object 182. Moreover, by positively identifying motion vectors 320 of one or more objects 182 being positioned within fresh food chamber 122, the confidence score 310 associated with the identification of a particular object 182 can be improved or increased.

In addition, identification of adjacent objects 182 of a plurality of objects and their associated motion vectors 320 can improve the confidence score 310 of an object identification and its associated motion vector 320. In this regard, for example, method 200 can include analyzing the first image 300 to identify a second object in the first image 300 (e.g., such as an apple positioned adjacent the orange). Method 200 can further include determining a spatial relationship between the first object 182 and the second object 182 (e.g., a relative positioning of the two objects in a three-dimensional space). Method 200 can further include determining a predicted motion vector of the second object (e.g., as identified generally by reference numeral 322) based at least in part on the motion vector 320 of the first object 182 and the spatial relationship between the first object in the second object.

Thus, method 200 can include obtaining a plurality of images of objects 182 being added to or removed from the chilled chamber. In this regard, continuing example from above, controller 156 or another suitable processing device can analyze these images to identify objects 182 and/or their trajectories into or out of fresh food chamber 122 and/or freezer chamber 124. By identifying whether objects 182 are being added to or removed from fresh food chamber 122 and/or freezer chamber 124, controller 156 can monitor and track inventory within refrigerator appliance 100. For example, controller 156 can maintain a record of food items positioned within or removed from fresh food chamber 122.

FIG. 3 depicts an example control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using camera assembly 190 as an example, it should be appreciated that these methods can be applied to the operation of any suitable appliance and/or camera assembly.

Inventory management system 180 and method 200 of operating a refrigerator appliance as described above can generally facilitate improved inventory management within a refrigerator appliance. In this regard, this system facilitates object identification where a frame-by-frame object analysis method can be used to support inventory management. This is advantageous when tracking multiple objects belonging to a single class (e.g., similar objects) stored in a refrigerator. In some embodiments, multiple images from a camera can be used for tracking items moving through its field of view, where objects are captured frame-by-frame. Objects can be compared for congruency between frames in a neural network. The neural network can be designed to give a probability that both images are of the same item. If multiple images of a single object are available multiple comparisons can be made, then the average confidence can be used.

The neural network effectively generates feature vectors or maps for each object and compares. High confidence vectors are given to objects that are positively identified between frames. Relative position between unknown items can be used to identify them in the next step. If items are moving together, another item can be located in a known position. If an item is not moving it will be found in the same position. Either case can be used to link an item identification between frames. An appliance-centric database can be built up over the course of one or more interactions with the appliance (e.g., many frames). Each image of the same item identification is available for future comparisons, making it easier and easier to track.

For example, if there is a 50% confidence that a given orange is the same orange based on a pair of frames, older images of the same orange can be run through the same comparison, yielding matches as high as 90% confidence with an average of 75%. Thus, using older images effectively can bring up the confidence of a match, e.g., by using maximum match confidence, using average match confidence, using other similar metrics such as quartiles, median, etc. Hence, the method is useful for tracking items going into the appliance to their final storage locations and an item age (e.g., even if an item is moved around). In addition, the method (e.g., method 200) determines which item is leaving the storage space when it is removed and also suggests the user to remove the oldest item and show it in an image.

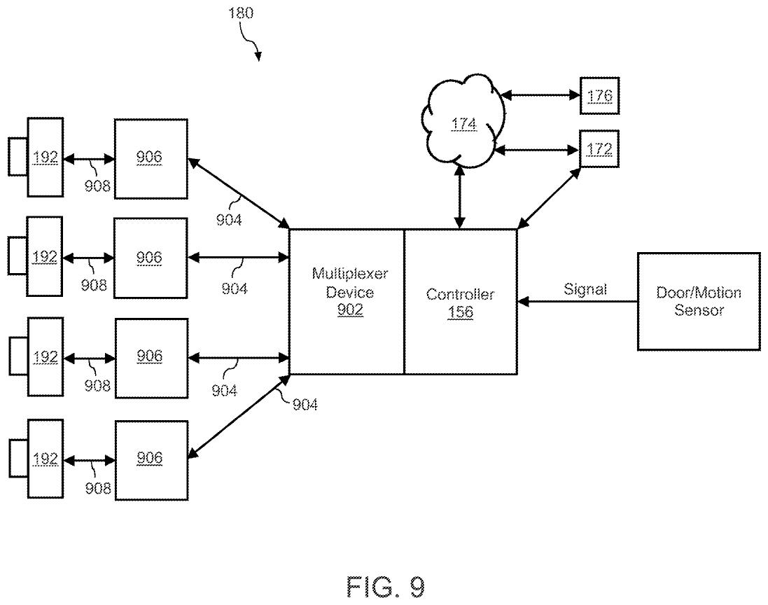

FIG. 9 illustrates a block diagram of inventory management system 180 according to one or more example embodiments of the present disclosure. Although not depicted in FIG. 9, inventory management system 180 illustrated in FIG. 9 can include camera assembly 190. In the example embodiment illustrated in FIG. 9, inventory management system 180 and/or camera assembly 190 can include a plurality of cameras 192 that can be coupled to a multiplexer device 902 via a plurality of electrical cables 904. For example, as illustrated in the embodiment depicted in FIG. 9, each camera 192 can be coupled to multiplexer device 902 via a single electrical cable 904, an adapter 906, and a camera cable 908. In this or another embodiment, multiplexer device 902 can be coupled to and/or integrated with a controller (e.g., a microprocessor) such as, for example, controller 156, which can constitute and/or include a single board computer (SBC). In at least one embodiment, controller 156 can include, be coupled to, constitute, and/or otherwise be associated with an image signal processor (ISP) that can be operable and/or configured to process image data, video data, and/or audio data according to one or more example embodiments described herein.

In some embodiments, each electrical cable 904 can constitute and/or include an analog cable, a digital cable, a communication cable, a network cable, a data cable, a media cable, a control cable, a coaxial cable, or another type of electrical cable. In some embodiments, each electrical cable 904 can constitute and/or include an electrical cable (e.g., a coaxial cable) that can be used to communicate image data, video data, audio data, control data (e.g., control signals), and/or other data between each camera 192 and controller 156.

In the example embodiment depicted in FIG. 9, each camera 192 can constitute and/or include a mobile industry processor interface (MIPI) camera (e.g., an MIPI camera module). In this or another embodiment, each camera cable 908 can constitute and/or include an MIPI camera cable. In this or another embodiment, each electrical cable 904 can constitute and/or include a coaxial cable. In this or another embodiment, each adapter 906 can constitute and/or include an MIPI to coaxial cable adapter.

Although some example embodiments of the present disclosure describe and/or depict use of coaxial cables, MIPI to coaxial cable adapters, MIPI camera cables, and MIPI cameras, the present disclosure is not so limiting. For example, use of other hardware operable to concurrently capture image data, video data, and/or audio data using a plurality of cameras, multiplex the different signals of the plurality of cameras into a single signal, and/or process the single signal using an image signal processor (ISP) (e.g., an ISP coupled to and/or integrated with a controller (e.g., an SBC)) can be implemented in accordance with one or more embodiments described herein without deviating from the intent and/or scope of the present disclosure. For instance, different combinations of other types of cameras (e.g., universal serial bus (USB) cameras), cables (e.g., USB cables), adapters, and/or different quantities of image signal processors (ISP) and/or single board computers (SBC) can be implemented in accordance with one or more embodiments described herein without deviating from the intent and/or scope of the present disclosure.

In at least one embodiment, cameras 192 can be operable to concurrently (e.g., simultaneously, at approximately the same time) capture data (e.g., image data, video data, audio data) associated with a chilled chamber such as, for instance, fresh food chamber 122 and/or freezer chamber 124. For example, cameras 192 can concurrently capture images and/or video of one or more objects 182 positioned within, being added to, and/or being removed from fresh food chamber 122 and/or freezer chamber 124. For instance, when a motion sensor (e.g., optical, acoustic, electromagnetic) and/or a door switch of refrigerator appliance 100 is triggered and/or detects a refrigerator door 128 is opened, inventory management system 180 and/or camera assembly 190 can use cameras 192 to concurrently capture images and/or video of one or more objects 182 being added to or removed from fresh food chamber 122. In this example, controller 156 can receive a signal indicating that a refrigerator door 128 and/or freezer door 130 is open (e.g., controller 156 can receive such a signal from a motion sensor and/or door sensor of refrigerator appliance 100). In this example, based at least in part on receipt of such a signal, controller 156 can operate (e.g., via inventory management system 180, camera assembly 190) one or more cameras 192 while refrigerator door 128 and/or freezer door 130 is open to concurrently capture such data associated with fresh food chamber 122 and/or freezer chamber 124, respectively (e.g., data associated with one or more objects 182 positioned within, being added to, and/or being removed from fresh food chamber 122 and/or freezer chamber 124).

In the example embodiment depicted in FIG. 9, multiplexer device 902 can be operable to multiplex different data signals concurrently provided to multiplexer device 902 by cameras 192 via electrical cables 904. In this or another embodiment, the different data signals can include data associated with fresh food chamber 122 and/or freezer chamber 124. For instance, the different data signals can include images such as, for example, images 300, 302 and/or video of one or more objects 182 being added to or removed from fresh food chamber 122 and/or freezer chamber 124. In at least one embodiment, multiplexer device 902 can also be operable to output a multiplex signal having the different data signals and the above-described data associated with fresh food chamber 122 and/or freezer chamber 124.

As illustrated in the example embodiment depicted in FIG. 9, multiplexer device 902 can be coupled to and/or integrated with a controller (e.g., a microprocessor, SBC) such as, for instance, controller 156. In at least one embodiment, controller 156 can receive the multiplex signal that can be output by multiplexer device 902 and can include the different data signals that can be concurrently captured and provided to multiplexer device 902 by cameras 192 as described above.

In alternative or additional embodiments, inventory management system 180 illustrated in the example embodiment depicted in FIG. 9 can include a demultiplexer device (not shown in FIG. 9) that can be coupled to multiplexer device 902 and controller 156. For example, in these alternative or additional embodiments, such a demultiplexer device can be coupled to and/or integrated with controller 156 and further coupled to multiplexer device 902 such that the demultiplexer device can demultiplex the multiplex signal output by multiplexer device 902. In these alternative or additional example embodiments, upon demultiplexing the multiplex signal, such a demultiplexer device can output the different data signals and provide them to controller 156.

In one or more embodiments, based at least in part on receipt of the above-described multiplex signal and/or the different data signals from multiplexer device 902, controller 156 can perform one or more operations. For example, as described above with reference to FIGS. 1-8, in some embodiments, controller 156 can analyze the multiplex signal, the different data signals, and/or the data therein locally (e.g., the data associated with fresh food chamber 122 and/or freezer chamber 124 that can be concurrently captured by cameras 192). For instance, controller 156 can use one or more of the above-described machine learning and/or AI models, algorithms, and/or image recognition processes (e.g., CNN, R-CNN, DBN, DNN) to analyze image data (e.g., data in images 300, 302) and/or video data that is associated with fresh food chamber 122 and/or freezer chamber 124 and is in the multiplex signal. In this example, controller 156 can analyze such image and/or video data to monitor and/or maintain a record of one or more objects 182 (e.g., food items, beverages) positioned within, being added to, and/or being removed from fresh food chamber 122 and/or freezer chamber 124.

In some embodiments, controller 156 can utilize external communication system 170 to communicate the multiplex signal, the different data signals, and/or the data associated with fresh food chamber 122 and/or freezer chamber 124 to external device 172 and/or remote server 176 via network 174. In some embodiments, controller 156 can facilitate adjustment of a camera 192 to adjust a monitoring range, a monitoring zone, or a field of view of such a camera 192. For example, in these embodiments, multiplexer device 902 can be coupled to and/or integrated with controller 156 such that controller 156 can be coupled (e.g., electrically, communicatively, operatively) to one or more electrical cables 904, which can be coupled to one or more cameras 192 (e.g., via adapter(s) 906 and camera cable(s) 908). In these embodiments, controller 156 can send one or more control signals to a camera 192 via an electrical cable 904 to, for example, facilitate the above-described adjustment of such a camera 192 and/or another operation associated with such a camera 192 (e.g., power on, power off, adjust camera settings).

It should be appreciated that positioning of MIPI cameras on and/or within refrigerator appliance 100 can be limited by the length of an MIPI camera cable coupled to and/or associated with each of such MIPI cameras (e.g., MIPI camera cables are approximately 12 inches in length). However, it should also be appreciated that by using a plurality of electrical cables 904, adapters 906, and camera cables 908 to couple cameras 192 to multiplexer device 902 and controller 156 as illustrated in FIG. 9, a plurality of cameras 192 can each be positioned at a different location on and/or within refrigerator appliance 100 (e.g., on and/or within cabinet 102, fresh food chamber 122, freezer chamber 124, refrigerator doors 128, freezer door 130). In this manner, in some embodiments, such a plurality of cameras 192 positioned at such various locations on and/or within refrigerator appliance 100 can be controlled using a single controller such as, for instance, controller 156. In these or other embodiments, images (e.g., a plurality of images 300, 302) and/or video captured (e.g., concurrently captured) by such a plurality of cameras 192 positioned at such various locations on and/or within refrigerator appliance 100 can be processed using a single image signal processor that can be coupled to and/or integrated with controller 156 (e.g., which can include and/or constitute an SBC). In these embodiments, inventory management system 180 illustrated in FIG. 9 can thereby reduce the quantity, design complexity, design footprint, and/or costs associated with hardware and/or software components used in refrigerator appliance 100 to concurrently obtain and/or process data associated with fresh food chamber 122 and/or freezer chamber 124 from a plurality of cameras 192 positioned at various locations on and/or within refrigerator appliance 100.

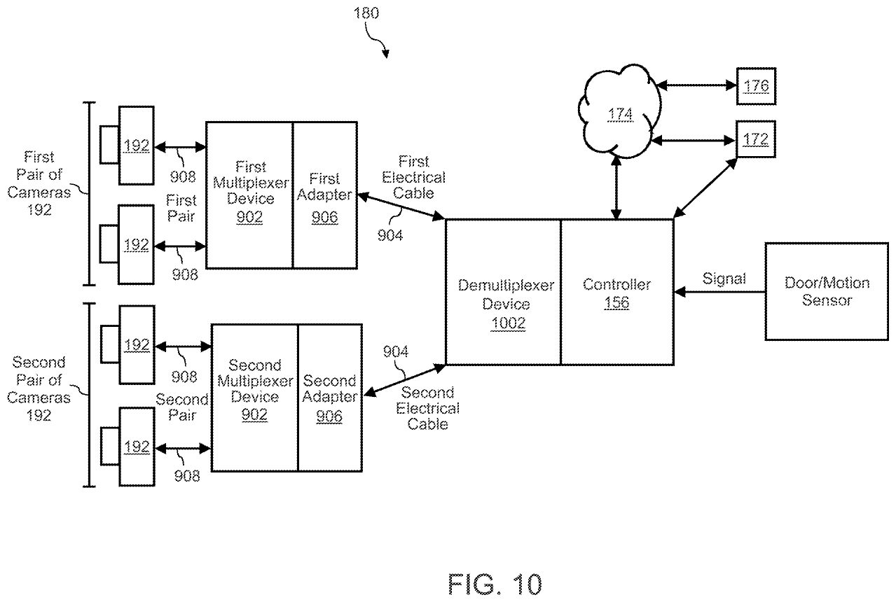

FIG. 10 illustrates a block diagram of inventory management system 180 according to one or more example embodiments of the present disclosure. For instance, inventory management system 180 illustrated in FIG. 10 can constitute an example, non-limiting alternative embodiment of inventory management system 180 illustrated in FIG. 9 and described above.

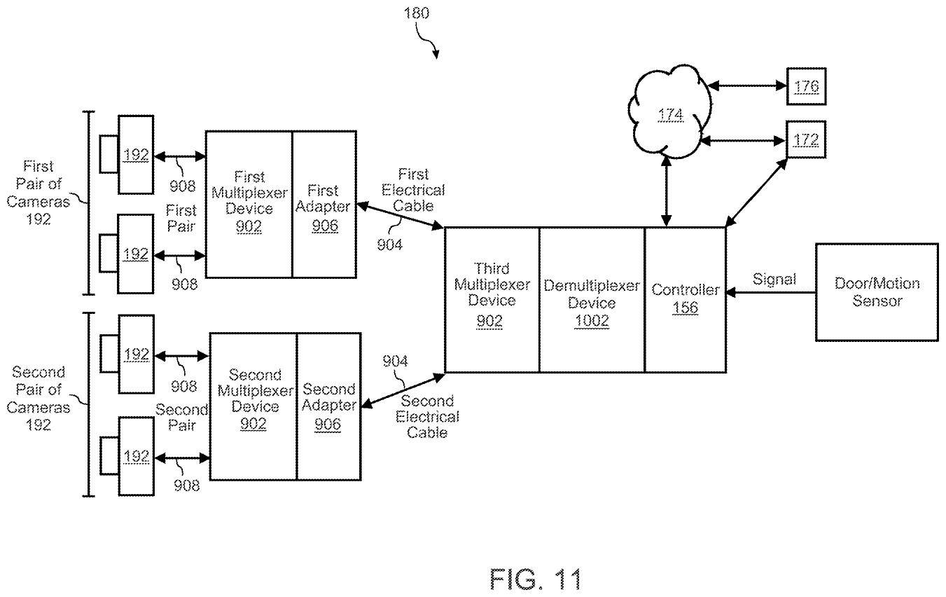

In the example embodiment depicted in FIG. 10, inventory management system 180 and/or camera assembly 190 (not shown in FIG. 10) can include a first multiplexer device 902 that can be coupled to a first pair of cameras 192 (e.g., via a first pair of camera cables 908, denoted in FIGS. 10 and 11 as “First Pair”) and a first electrical cable 904 (e.g., via a first adapter 906). In this example embodiment, such a first multiplexer device 902 can be operable to output a first multiplex signal onto such a first electrical cable 904, where the first multiplex signal can include different first data signals that can be concurrently provided to first multiplexer device 902 by first pair of cameras 192 (e.g., via first pair of camera cables 908, denoted in FIGS. 10 and 11 as “First Pair”). In this example embodiment, the different first data signals can include the above-described data associated with fresh food chamber 122 and/or freezer chamber 124 that can be concurrently captured by first pair of cameras 192 (e.g., via images, video, audio).

In the example embodiment depicted in FIG. 10, inventory management system 180 and/or camera assembly 190 (not shown in FIG. 10) can further include a second multiplexer device 902 that can be coupled to a second pair of cameras 192 (e.g., via a second pair of camera cables 908, denoted in FIGS. 10 and 11 as “Second Pair”) and a second electrical cable 904 (e.g., via a second adapter 906). In this example embodiment, such a second multiplexer device 902 can be operable to output a second multiplex signal onto such a second electrical cable 904, where the second multiplex signal can include different second data signals that can be concurrently provided to second multiplexer device 902 by second pair of cameras 192 (e.g., via second pair of camera cables 908, denoted in FIGS. 10 and 11 as “Second Pair”). In this example embodiment, the different second data signals can include the above-described data associated with fresh food chamber 122 and/or freezer chamber 124 that can be concurrently captured by second pair of cameras 192 (e.g., via images, video, audio).

In the example embodiment depicted in FIG. 10, first pair of cameras 192 and second pair of cameras 192 can concurrently (e.g., simultaneously) capture the above-described image data, video data, and/or audio data associated with fresh food chamber 122 and/or freezer chamber 124. In this example embodiment, first pair of cameras 192 and second pair of cameras 192 can concurrently (e.g., simultaneously) provide such image data, video data, and/or audio data to first multiplexer device 902 and second multiplexer device 902, respectively, via the different first data signals and the different second data signals, respectively.

In the example embodiment depicted in FIG. 10, inventory management system 180 and/or camera assembly 190 (not shown in FIG. 10) can further include a demultiplexer device 1002 that can be coupled to first electrical cable 904 and second electrical cable 904. In this example embodiment, demultiplexer device 1002 can be operable to demultiplex the first multiplex signal into the different first data signals and the second multiplex signal into the different second data signals. In this example embodiment, demultiplexer device 1002 can be coupled to and/or integrated with a controller such as, for example, controller 156. In this example embodiment, demultiplexer device 1002 can provide the different first data signals and/or the different second data signals to controller 156 upon demultiplexing the first multiplex signal and/or the second multiplex signal, respectively.

In the example embodiment depicted in FIG. 10, based at least in part on receipt of the different first data signals and/or the different second data signals from demultiplexer device 1002, controller 156 can perform one or more operations. For example, controller 156 can perform one or more of the operations described above with reference to the example embodiments depicted in FIGS. 1-9. For instance, controller 156 can: locally analyze (e.g., via a CNN, R-CNN, DBN, and/or DNN model, algorithm, and/or process) image data of images 300, 302 and/or video data; monitor and/or maintain a record of object(s) 182; communicate (e.g., via external communication system 170 and network 174) the signal(s) and/or data to external device 172 and/or remote server 176; adjust a monitoring range, a monitoring zone, or a field of view of a camera 192; and/or perform another operation based at least in part on receipt of the different first data signals and/or the different second data signals from demultiplexer device 1002.

FIG. 11 illustrates a block diagram of inventory management system 180 according to one or more example embodiments of the present disclosure. For instance, inventory management system 180 illustrated in FIG. 11 can constitute an example, non-limiting alternative embodiment of inventory management system 180 illustrated in FIG. 10 and described above.

In the example embodiment depicted in FIG. 11, inventory management system 180 and/or camera assembly 190 (not shown in FIG. 11) can include a third multiplexer device 902 that can be coupled to first electrical cable 904, second electrical cable 904, and demultiplexer device 1002. In this example embodiment, third multiplexer device 902 can be operable to multiplex the first multiplex signal and the second multiplex signal that can be concurrently provided by first multiplex device 902 and second multiplex device 902, respectively. In this example embodiment, based on multiplexing the first multiplex signal and the second multiplex signal, third multiplexer device 902 can output a third multiplex signal that can include the different first data signals and the different second data signals described above. For instance, third multiplexer device 902 can output a third multiplex signal that can include the different first data signals and the different second data signals that can be concurrently provided by first pair of cameras 192 and second pair of cameras 192, respectively, as described above with reference to FIG. 10.

In some embodiments, third multiplexer device 902 and/or demultiplexer device 1002 can be coupled to and/or integrated with a controller such as, for instance, controller 156 as illustrated in FIG. 11. In the example embodiment depicted in FIG. 11, third multiplexer device 902 can provide the third multiplex signal to demultiplexer device 1002. In this example embodiment, demultiplexer device 1002 can be operable to demultiplex the third multiplex signal into: the first multiplex signal and the second multiplex signal; or the different first data signals and the different second data signals described above. In some embodiments, third multiplexer device 902 can be coupled directly to controller 156 such that third multiplexer device 902 can provide the third multiplex signal to controller 156. In the example embodiment depicted in FIG. 10 or another embodiment, based at least in part on receipt of the first multiplex signal, the second multiplex signal, the third multiplex signal, the different first data signals, and/or the different second data signals from demultiplexer device 1002 and/or third multiplexer device 902, controller 156 can perform one or more operations. For example, controller 156 can perform one or more of the operations described above with reference to the example embodiments depicted in FIGS. 1-9. For instance, controller 156 can: locally analyze (e.g., via a CNN, R-CNN, DBN, and/or DNN model, algorithm, and/or process) image data of images 300, 302 and/or video data; monitor and/or maintain a record of object(s) 182; communicate (e.g., via external communication system 170 and network 174) the signal(s) and/or data to external device 172 and/or remote server 176; adjust a monitoring range, a monitoring zone, or a field of view of a camera 192; and/or perform another operation based at least in part on receipt of the different first data signals and/or the different second data signals from demultiplexer device 1002.

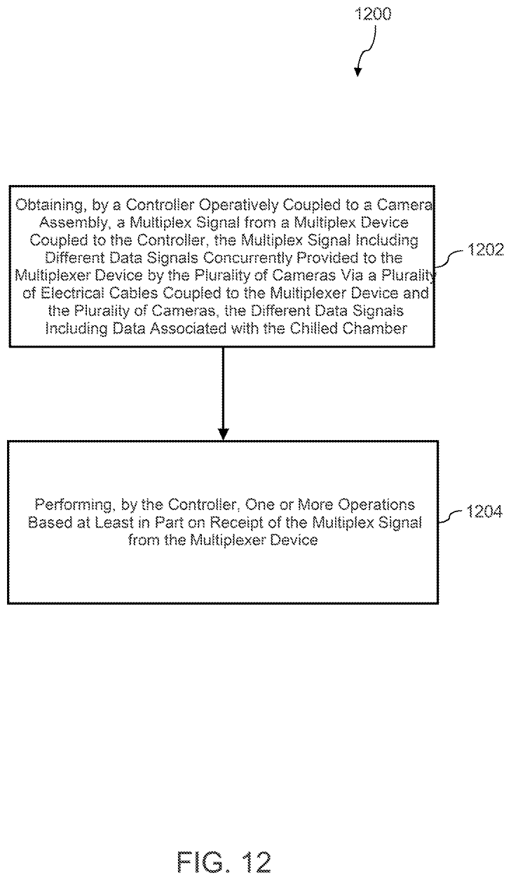

FIG. 12 illustrates a flow diagram of an example, non-limiting method 1200 to operate inventory management system 180 described above and illustrated in FIGS. 2, 8, and/or 9 according to one or more example embodiments of the present disclosure. Method 1200 may be implemented using, for instance, controller 156, inventory management system 180 (e.g., the embodiments of inventory management system 180 described above and illustrated in FIGS. 2, 8, and/or 9), and/or camera assembly 190 (e.g., the embodiments of camera assembly 190 described above and illustrated in FIGS. 2, 8, and/or 9). In some embodiments, method 1200 can constitute an example method to implement inventory management within a refrigerator appliance (e.g., refrigerator appliance 100), where the refrigerator appliance can include a chilled chamber (e.g., fresh food chamber 122, freezer chamber 124) and a camera assembly (e.g., camera assembly 190) having a plurality of cameras (e.g., cameras 192) positioned to monitor the chilled chamber.

The example embodiment illustrated in FIG. 12 depicts operations performed in a particular order for purposes of illustration and discussion. Those of ordinary skill in the art, using the disclosures provided herein, will understand that various operations or steps of method 1200 or any of the other methods disclosed herein may be adapted, modified, rearranged, performed simultaneously, include operations not illustrated, and/or modified in various ways without deviating from the scope of the present disclosure.

At 1202, method 1200 can include obtaining, by a controller (e.g., controller 156) operatively coupled to a camera assembly (e.g., camera assembly 190), a multiplex signal (e.g., the multiplex signal described above with reference to FIG. 9) from a multiplex device (e.g., multiplexer device 902) coupled to the controller, the multiplex signal including different data signals (e.g., the different data signals described above with reference to FIG. 9) concurrently provided to the multiplexer device by the plurality of cameras via a plurality of electrical cables (e.g., electrical cables 904) coupled to the multiplexer device and the plurality of cameras, the different data signals including data associated with the chilled chamber (e.g., data associated with one or more objects 182 positioned within, being added to, and/or being removed from fresh food chamber 122 and/or freezer chamber 124).

Although not depicted in FIG. 12, in some embodiments, method 1200 can include obtaining, by the controller, a signal indicating a door associated with the chilled chamber is open (e.g., a signal from a motion sensor and/or a door switch of refrigerator appliance 100. In these embodiments, method 1200 can further operating, by the controller, the plurality of cameras while the door is open to concurrently capture the data associated with the chilled chamber based at least in part on receipt of the signal (e.g., as described above with reference to FIG. 9).

At 1204, method 1200 can include performing, by the controller, one or more operations based at least in part on receipt of the multiplex signal from the multiplexer device (e.g., controller 156 can perform one or more of the operations described above with reference to the example embodiments depicted in FIGS. 1-9). For example, although not depicted in FIG. 12, in some embodiments, method 1200 can include implementing, by the controller, a machine learning image recognition process (e.g., a CNN, R-CNN, DBN, and/or DNN process) to analyze the data associated with the chilled chamber based at least in part on receipt of the multiplex signal from the multiplexer device.

In another example, although not depicted in FIG. 12, in some embodiments, method 1200 can include analyzing, by the controller, the data associated with the chilled chamber based at least in part on receipt of the multiplex signal from the multiplexer device. In this example, method 1200 can further include maintaining, by the controller, a record of food items positioned within or removed from the chilled chamber based at least in part on analysis of the data associated with the chilled chamber.

In another example, although not depicted in FIG. 12, in some embodiments, method 1200 can include providing, by the controller (e.g., via network 174), the multiplex signal, the different data signals, and/or the data associated with the chilled chamber to one or more remote computing devices external to the refrigerator appliance using an external communication system (e.g., external communication system 170) coupled to the controller.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A refrigerator appliance comprising:
a cabinet defining a chilled chamber;
a door being rotatably hinged to the cabinet to provide selective access to the chilled chamber;
a camera assembly coupled to the cabinet and operable to monitor the chilled chamber, the camera assembly comprising:
a plurality of cameras coupled to a plurality of electrical cables, the plurality of cameras operable to concurrently capture data associated with the chilled chamber, each camera of the plurality of cameras coupled to an electrical cable of the plurality of electrical cables;
a multiplexer device coupled to the plurality of electrical cables, the multiplexer device operable to multiplex different data signals concurrently provided to the multiplexer device by the plurality of cameras via the plurality of electrical cables and output a multiplex signal comprising the different data signals, the different data signals comprising the data associated with the chilled chamber;
a demultiplexer device coupled to the controller and the multiplexer device, the demultiplexer device operable to demultiplex the multiplex signal and output the different data signals; and
a controller coupled to the multiplexer device through the demultiplexer device, the controller configured to perform one or more operations based at least in part on receipt of the different data signals from the demultiplexer.

2. (canceled)

3. The refrigerator appliance of claim 1, wherein the electrical cable and each electrical cable of the plurality of electrical cables comprises a coaxial cable, and wherein each camera of the plurality of cameras comprises a mobile industry processor interface camera.

4. The refrigerator appliance of claim 1, wherein each camera of the plurality of cameras is coupled to the electrical cable of the plurality of electrical cables via a mobile industry processor interface camera cable.

5. The refrigerator appliance of claim 1, wherein each camera of the plurality of cameras is coupled to a different portion of the cabinet, wherein each camera of the plurality of cameras is operable to monitor a specified monitoring zone or range, and wherein each camera of the plurality of cameras has a field of view directed to a monitoring zone or range specified for the camera.

6. The refrigerator appliance of claim 1, wherein the data associated with the chilled chamber comprises at least one of image data, video data, or audio data.

7. The refrigerator appliance of claim 1, wherein the controller is configured to use a machine learning image recognition process to analyze the data associated with the chilled chamber.

8. The refrigerator appliance of claim 7, wherein the machine learning image recognition process comprises at least one of a convolution neural network, a region-based convolution neural network, a deep belief network, or a deep neural network image recognition process.

9. The refrigerator appliance of claim 1, wherein the controller is configured to maintain a record of food items positioned within or removed from the chilled chamber based at least in part on an analysis of the data associated with the chilled chamber.

10. The refrigerator appliance of claim 1, further comprising an external communication system coupled to the controller, the external communication system operable to communicate with one or more remote computing devices external to the refrigerator appliance, wherein the controller is configured to provide at least one of the multiplex signal, the different data signals, or the data associated with the chilled chamber to the one or more remote computing devices using the external communication system.

11. The refrigerator appliance of claim 1, wherein the controller is configured to:
obtain a signal indicating the door of the refrigerator appliance is open; and
operate the plurality of cameras while the door is open to concurrently capture the data associated with the chilled chamber based at least in part on receipt of the signal.

12. A method of implementing inventory management within a refrigerator appliance, the refrigerator appliance comprising a chilled chamber and a camera assembly comprising a plurality of cameras positioned to monitor the chilled chamber, the method comprising:
obtaining, by a controller operatively coupled to the camera assembly, a demultiplexed data signal received from a demultiplexer device and generated from a multiplex signal from a multiplex device coupled to the controller through the demultiplexer device, the multiplex signal comprising different data signals concurrently provided to the multiplexer device by the plurality of cameras via a plurality of electrical cables coupled to the multiplexer device and the plurality of cameras, the different data signals comprising data associated with the chilled chamber; and
performing, by the controller, one or more operations based at least in part on receipt of the multiplex signal from the multiplexer device.

13. The method of claim 12, further comprising:
implementing, by the controller, a machine learning image recognition process to analyze the data associated with the chilled chamber based at least in part on receipt of the multiplex signal from the multiplexer device.

14. The method of claim 12, further comprising:
analyzing, by the controller, the data associated with the chilled chamber based at least in part on receipt of the multiplex signal from the multiplexer device; and
maintaining, by the controller, a record of food items positioned within or removed from the chilled chamber based at least in part on analysis of the data associated with the chilled chamber.

15. The method of claim 12, further comprising:
providing, by the controller, at least one of the multiplex signal, the different data signals, or the data associated with the chilled chamber to one or more remote computing devices external to the refrigerator appliance using an external communication system coupled to the controller.

16. The method of claim 12, further comprising:
obtaining, by the controller, a signal indicating a door associated with the chilled chamber is open; and
operating, by the controller, the plurality of cameras while the door is open to concurrently capture the data associated with the chilled chamber based at least in part on receipt of the signal.

17. A refrigerator appliance comprising:
a cabinet defining a chilled chamber;
a door being rotatably hinged to the cabinet to provide selective access to the chilled chamber;
a camera assembly coupled to the cabinet and operable to monitor the chilled chamber, the camera assembly comprising:
a first multiplexer device coupled to a first pair of cameras and a first electrical cable, the first multiplexer device operable to output a first multiplex signal onto the first electrical cable, the first multiplex signal comprising different first data signals concurrently provided to the first multiplexer device by the first pair of cameras;
a second multiplexer device coupled to a second pair of cameras and a second electrical cable, the second multiplexer device operable to output a second multiplex signal onto the second electrical cable, the second multiplex signal comprising different second data signals concurrently provided to the second multiplexer device by the second pair of cameras;
a demultiplexer device coupled to the first electrical cable and the second electrical cable, the demultiplexer device operable to demultiplex the first multiplex signal into the different first data signals and the second multiplex signal into the different second data signals; and
a controller coupled to the demultiplexer device, the controller configured to perform one or more operations based at least in part on receipt of at least one of the different first data signals or the different second data signals from the demultiplexer.

18. The refrigerator appliance of claim 17, wherein each electrical cable of the first electrical cable and the second electrical cable comprises a coaxial cable, wherein each camera of the first pair of cameras and the second pair of cameras comprises a mobile industry processor interface camera, and wherein the different first data signals and the different second data signals are concurrently provided by the first pair of cameras and the second pair of cameras, respectively, to the first multiplexer device and the second multiplexer device, respectively.

19. The refrigerator appliance of claim 17, a third multiplexer device coupled to the first electrical cable, the second electrical cable, and the demultiplexer device, the third multiplexer device operable to multiplex the first multiplex signal and the second multiplex signal concurrently provided by the first multiplex device and the second multiplex device, respectively, to output a third multiplex signal comprising the different first data signals and the different second data signals, wherein the different first data signals and the different second data signals are concurrently provided by the first pair of cameras and the second pair of cameras, respectively.

20. The refrigerator appliance of claim 19, wherein the demultiplexer device is operable to demultiplex the third multiplex signal into at least one of: the first multiplex signal and the second multiplex signal; or the different first data signals and the different second data signals.

21. The refrigerator appliance of claim 1, wherein the demultiplexer device electrically couples the multiplexor device to the controller.
